(19) United States
(12) Patent Application Publication
(10) Pub. No.: US 2015/0316322 A1
(43) Pub. Date: Nov. 5, 2015

(54) DEVICE FOR TURNING, MIXING AND TRANSPORTING PARTIALLY DRIED MATERIAL TO BE DRIED OR DRIED MATERIAL

(71) Applicant: TSP GMBH, Filderstadt-Bernhausen (DE)

(72) Inventors: Markus Bus, Pliezhausen (DE); Steffen Ritterbusch, Stuttgart (DE); Tilo Conrad, Nurtingen (DE)

(73) Assignee: TSP GmbH, Filderstadt-Bernhausen (DE)

(21) Appl. No.: 14/653,939

(22) PCT Filed: Dec. 5, 2013
(86) PCT No.: PCT/EP2013/075658

§ 371 Date: Jun. 19, 2015

(30) Foreign Application Priority Data
Dec. 21, 2012 (DE) 10 2012 224 322.4

(51) Int. Cl. F26B 25/04; F26B 25/00; C02F 11/12

(52) U.S. Cl. CPC F26B 25/04; C02F 11/12; F26B 25/002

(57) ABSTRACT

The invention relates to a device (8) for turning, mixing and transporting partially dried material to be dried or dried material (10) in a drying facility in which the material (10) is placed on a floor (12) and spread out for drying. The device (8) has a rotatable shaft (14) oriented substantially parallel to the floor (12), trough-like scoops (16) being arranged around and along the shaft (14), such that the scoops (16) are moved around the shaft (14) in a circle during rotation of the shaft (14). The device (8) is arranged above the floor (12) so as to be displaceable in opposite movement directions (13, 19) in such a manner that, during displacement above the floor (12), the shaft (14) is moved substantially parallel to the floor (12) and vertically in one of the movement directions (13, 19). The device (8) has a drive device with adjustable rotational speed in one rotation direction for rotating the shaft (14) having the scoops (16).

The invention relates to a device for turning, mixing, and transporting material to be dried, partially dried material or dried material in a drying facility, in which the material is placed on a floor and is spread out for drying. The material can be sludge, in particular sewage sludge. The device has a rotatable axis oriented parallel or substantially parallel to the floor, scoops being arranged around and along the axis such that the scoops are moved around the axis in a circle during rotation of the axis. The mixing is, in particular, back-mixing dried or partially dried material with moister material in order to increase the dry-substance content of the moister material and, therefore, to reduce the stickiness thereof.

Document DE 298 14 380 U1 discloses a device for drying sludge and/or the ingredients of contaminated fluids with the aid of solar radiation within a substantially closed drying space. The material to be dried is placed into a container, which is open toward the top, and is circulated therein by means of a turning device engaging into the container, wherein said turning device has turning scoops. A plurality of turning devices can be provided, the effective regions of which touch or overlap one another. The turning device can also be moved back and forth, however, transverse to the orientation of the horizontal rotating axis thereof comprising turning scoops.

A turning device is known from DE 10 2004 037 209 A1. According thereto, a retaining device for the moist material is arranged directly outside of the circle and substantially above a layer of the moist material to be dried, said retaining device interacting with a scoop of this device. The cross section of the scoop can correspond to a semicircular polygon outline. The retaining device interacts with the scoop and makes it particularly easy to pick up the moist material, in particular also conglomerates, onto the scoop. Said retaining device prevents conglomerates from being pushed in front of the scoop and not entering the turning device. The moist material is picked up in front of the turning device during the turning operation and is unloaded behind said turning device such that the moist material is transported in the longitudinal direction through the drying facility during the turnover, by the displacement of the turning device. Transporting the moist material further during turning over results in a moisture gradient setting in along the length of the drying bed. As a result, moist material can be applied at one end of the facility, while a uniformly, thoroughly dried drying material is discharged at the other end.

The moist material can also be turned over on the spot without being transported further. Turning over can be carried out during forward and reverse travel of the turning device. Effective transport in the direction of the discharge side by means of the turning device is only possible, however, when the turning device travels forward in the direction of transport of the moist material, but not during travel in reverse toward the side of the application of the moist material. The turning device must travel back in order to further transport the material to be dried, without it being possible to transport the material to be dried in the discharge direction. This costs time and energy.

Due to the relatively slow transport, the drying performance can be limited given a good heat supply, e.g., by means of waste heat recovery or solar radiation in the middle of summer, because already dried material cannot be discharged from the drying facility quickly enough and material to be dried cannot be distributed on the floor quickly enough. In the case of a drying facility, if the surface forming the floor is too long for a given application capacity of moist sludge, the sludge is already dry, given favorable drying conditions, long before said sludge has reached the discharge side. In this case, the available drying surface cannot be efficiently utilized, since already dried sludge, from which no more water can be withdrawn, is located on the surface. The maximum transport performance of the turning device therefore limits the maximum length of the surface that can be reasonably processed using the turning device.

If this problem is solved by a plurality of drying surfaces arranged next to one another, this requires a plurality of the turning devices, since the width thereof is limited for design reasons. The length, which is limited by the conveying performance of the turning device, therefore has a substantial influence on the investment costs of a drying facility. Moreover, in the case of a drying facility having a drying surface covered by a greenhouse-type building cover, the surface-specific costs of the drying facility increase with the width of the drying surface due to the construction outlay for the building cover, which construction outlay is higher for structural reasons.

The problem addressed by the present invention is that of developing further the design of a turning device with relatively little outlay such that the transport performance thereof is increased. In addition, a method for transporting material to be dried, partially dried material or dried material and a use of a device for turning, mixing, and transporting material to be dried, partially dried material or dried material are to be indicated.

The problem is solved by the features of claims 1, 11, and 13. Advantageous embodiments of the invention will become apparent from the features of claims 2 to 10 and 12.

According to the invention, a device for turning, mixing, and transporting material to be dried, partially dried material or dried material in a drying facility is provided. In the drying facility, the material is placed on a floor and spread out for drying. The device has a rotatable axis oriented parallel or substantially parallel to the floor, trough-like scoops being arranged around and along the axis such that the scoops are moved around the axis in a circle during rotation of the axis. The device is arranged above the floor so as to be displaceable in opposite movement directions in such a manner that, during displacement above the floor, the axis is moved parallel or substantially parallel to the floor and in one of the movement directions perpendicular to the axis. In addition, the device comprises a drive device for rotating the axis having the scoops at an adjustable speed of rotation in one direction of rotation. The scoops each have an opening bordered by opposing edges. The two edges are formed by a wall extending from one of the edges to the other of the edges or are each formed by a wall connected to a base of the scoop. If the respective scoop is formed by the wall extending from one of the edges to the other of the edges, the scoop can have a semicircular cross section, for example. In a cross section extending perpendicular to the axis and parallel to the movement directions, it is possible, for each of the scoops, to draw two straight lines, each of which extends radially from the axis, and which enclose an angle γ of 72° at the most, wherein, on opposite sides of the scoop and independently of one another, each of the straight lines either overlaps, in one section, with the wall or one of the walls, is tangent to the wall or one of the walls on an outer side of the scoop, intersects the wall or one of the walls, wherein an angle 13 between the respective straight line and the wall or one of the walls is less than 15°, in particular less than 12°, in particular less than 10°, or intersects the wall or one of the walls at an inflection point of a curvature of the wall or one of the walls. The respective straight line and another straight line enclose an angle a at a part of the wall located at the rear in the direction of rotation or at the wall located at the rear in the direction of rotation, wherein the other straight line extends from one point, at which the straight line is tangent to or intersects the wall or at which the section ends at a side of the section located closer to the edge, wherein this point does not coincide with the edge, to the edge located closest to this point, wherein 0°<α≦60°.

Since the angle β occurs only in the case in which the straight lines each intersect the wall or one of the walls, β is always greater than 0°. Given that the angle α between the straight line and the other straight line is also greater than 0°, a section of the wall directly adjacent to the edge is always bent or curved in the direction of rotation, in the part of the wall located at the rear in the direction of rotation or in the wall located at the rear in the direction of rotation. By means of the combination of features of the device according to the invention, the scoops are each arranged such that these have an opening facing away from the axis and can engage into the material, by rotation of the axis, such that the material is picked up and transported in the scoop above the rotating axis and then falls out of the scoop as the rotation of the axis continues. The shape of the scoops also permits the material to be pushed underneath the axis and beyond during rapid rotation of the axis, without said material being picked up in the scoops. The axis can extend centrally through a shaft or a cylinder on which the scoops are directly or indirectly mounted. In the case of adjacently arranged scoops, an edge and/or a wall of one scoop can coincide with an edge and/or a wall of the adjacent scoop.

The device has the advantage that, due to the trough-shaped design of the scoops, each of which has an opening facing away from the axis, a relatively large quantity of material can be picked up by each of the scoops. The device also makes it possible to convey the material toward the discharge side of the drying facility, both during displacement of the device in the transport direction of the material and during displacement in the opposite direction. For this purpose, during displacement of the device in the transport direction, the axis is always positioned with spacing above the floor such that the scoops engage into the material during rotation of the axis. The direction of rotation is selected such that at least one of the scoops close to the floor moves in the direction of transport of the material and against the material. By means of the rotation, the scoops engage into the material, pick up said material, transport this in the scoops above the rotating axis and allow said material to fall out of the scoops as rotation continues in the direction of rotation. The axis is thereby displaced in the transport direction so far that, as a result, the material is unloaded from the scoops closer to the discharge side than where said material was positioned when picked up in the respective scoop. After the material is picked up, any material that may have fallen out of the scoops causes the material to become piled up in front of the scoops, which are rotating and moving in the transport direction. Therefore, more material can be picked up by the individual scoops and the transport can be supported as a result.

When the axis is displaced against the transport direction, this axis can be rotated in the direction of rotation so quickly that the scoops engaging into the material transport said material underneath the axis and beyond, in the transport direction, and, optionally, sling said material in this direction without loading said material into the scoops. As a result, the material is displaced in the transport direction. Loosening material that may be adhering to the scoops, from said scoops, is supported in the transport direction by rapid rotation of the axis.

It has been shown that the indicated range for the angle a is advantageous on the one hand for picking up the material into the scoops during the above-described slow rotational movement, but on the other hand at the above-described faster rotational movement, for only transporting said material underneath the axis and beyond without being loaded into the scoops.

In addition, the material can be mixed and turned over by means of the device in that the device, after having picked up the material in one of the scoops, is not displaced or is displaced only so far that the material is unloaded, as rotation continues, at the same position or substantially the same position at which said material was picked up by the respective scoop.

Due to the possibility of transporting the material toward the discharge side very effectively by the axis traveling forward as well as in reverse, the transport performance of the device is substantially increased relative to the device known from DE 10 2004 037 209 A1. As a result, the maximum length of the floor used for drying can be increased, thereby lowering the investment costs per unit of area or per unit of weight of the material to be dried. Even when drying occurs under favorable conditions, such as in the middle of summer or by the use of waste heat, the drying facility can be operated efficiently with the device according to the invention without it being possible for already-dried material not to be discharged in a timely manner and thereby block the floor for the application of more material to be dried.

Another advantage of the device according to the invention is that said device can be used in order to purposely transport material to be dried, partially dried material or dried material in a drying facility, in which the material is placed on a floor and spread out for drying, to any region of the floor. For this purpose, the axis is positioned with such spacing above the floor that the scoops engage into the material during rotation of the axis. The axis is displaced, in a movement direction, toward the material to be transported and thereby rotates in such a direction of rotation that at least one of the scoops close to the floor moves in the movement direction and against the material, wherein the scoop, by the rotation thereof, engages into the material and picks this up. The material is then lifted up in the scoop by means of the rotation, wherein the axis and, therefore, the scoop, are then held in such a position that the material remains in the scoop, wherein the device is then displaced to a position over the region of the floor at which the axis is then rotated such that the material contained in the scoop falls out of the scoop.

As an alternative, the material can be introduced from above into one of the scoops, e.g., by means of a wheel loader, a conveyor auger, a troughed chain conveyor, a spiral conveyor, a conveyor belt, or any other type of conveyor device, and is held there, wherein the device is then displaced to a position over the region of the floor at which the axis is then rotated such that the material contained in the scoop falls out of the scoop. Depending on the requirement, the axis can be lifted up before being displaced in order to not be obstructed during displacement by material present on the floor.

If the value for y exceeds 72°, it becomes increasingly ineffective to pick up the material in the scoops merely by rotating the axis, because, in that case, too much material falls out of the scoop before said material is transported in the scoops above the rotating axis. In order to reduce this falling-out, γ in one embodiment of the invention is 60° at the most.

It is possible that 0°<α≦50°, in particular 0°<α≦45°. Depending on the consistency of the dry material, these ranges of a can result in more effective transport of the material in the transport direction.

The edge of the part of the wall located at the rear in the direction of rotation or of the wall located at the rear in the direction of rotation can form, in the cross section, the element of the scoop that is spaced furthest from the axis. Provided that both edges are not spaced equally far from the axis, this means that the edge located at the rear in the direction of rotation protrudes further than the other edge. The picking up of the material in the scoop is simplified as a result.

The drive device can be designed such that this enables the axis to selectively rotate in the direction of rotation and in another, opposite, direction of rotation.

In an embodiment of the device according to the invention, the device is guided in an undercarriage, in particular an undercarriage comprising an additional drive device, on each of the two sides of the axis or on a shaft that forms the axis. For example, the floor can be formed by a rectangular or substantially rectangular surface and the undercarriage can be guided on rails or tracks on both sides of or at the longitudinal sides of the surface and/or at/on a boundary wall arranged along the surface. The boundary wall simultaneously has the function of preventing the material to be dried from being slung outwardly during turning over, mixing, or transport and thereby contaminating, e.g., a greenhouse-type building cover of the drying facility. In order to prevent such contamination, a shield for preventing a lateral distribution of the material can also be arranged on both sides of the axis and the scoops, laterally at the device. When such shields are provided, the boundary wall can be left out. Investment costs can be saved as a result. The shields can be sheet-metal plates, for example.

In an embodiment of the invention, the device comprises a means, which, in particular, rotates about another axis and, in particular, is replaceable, for scratching or scraping out the scoops in order to free said scoops from material adhering therein. As a result, the device can also be used to transport relatively moist and, therefore, sticky sludge and other material without the sludge or other material remaining by being stuck in the scoops. As a result, relatively moist sludge or other material can also be transported by the device from the application region into regions in which the sludge or the material is already dried or is partially dried and be mixed with this sludge or material. Due to the means for scratching or scraping out, the device can also be used to process very sticky and, therefore, heavy sludge without the device undergoing weight-induced deformation or damage. As a result, the back-mixing of partially dried sludge with sticky, relatively moist sludge in order to reduce the stickiness thereof—which back—mixing is often utilized in the prior art—is no longer necessary. The efficiency of the drying facility is also increased as a result.

In an embodiment of the device according to the invention, the spacing between the floor and the axis can be changed, in particular by means of another drive device. In this case, or as an alternative, the device can rest on the floor by means of a spacer, which ensures a minimum spacing between the floor and the scoops and, in particular, which comprises at least one roller. When the device is guided over the floor, irregularities in the floor are automatically compensated for by the spacer such that the spacing between the axis and the floor always remains virtually the same.

In an embodiment of the device according to the invention, said device is designed such that at least one respectively uppermost scoop is accessible from above such that it can be filled with material. The filling can take place, e.g., by means of a wheel loader or a conveyor mechanism. The material filled into the scoop can then be unloaded at any point on the surface.

The invention further relates to a method for transporting material to be dried, partially dried material or dried material with a transport device in a drying facility, in which the material is placed on a floor and is spread out for drying, wherein the transport device has a rotatable axis oriented parallel or substantially parallel to the floor, trough-like scoops being arranged around and along the axis such that the scoops are moved round the axis in a circle during rotation of the axis, wherein the transport device is arranged above the floor so as to be displaceable in opposite movement directions such that, during displacement above the floor, the axis is moved parallel or substantially parallel to the floor and in one of the movement directions perpendicular to the axis, wherein the transport device comprises a drive device for rotating the axis having the scoops at an adjustable speed of rotation in one direction of rotation. The floor is formed by an elongated surface, wherein the material is applied on a first of the shorter sides of the surface, is then transported along the surface by means of the transport device, and is discharged on a second of the shorter sides of the surface. For this purpose, the axis is always positioned with such spacing above the floor that the scoops engage into the material during rotation of the axis.

The axis is displaced in a first movement direction in the direction of the second of the shorter sides and is thereby rotated in such a direction of rotation that at least one of the scoops close to the floor moves in the first movement direction and against the material, wherein the scoops, by the rotation thereof, engage into the material, pick up said material, transport this in the scoops above the rotating axis and then allow said material to fall out of the scoops as the rotation continues in the direction of rotation. The axis is thereby displaced in the first movement direction so far that, as a result, the material is unloaded from the scoops closer to the second side than where said material was positioned when picked up in the respective scoop. In addition, the axis can be displaced in a second movement direction that is opposite the first movement direction and can thereby be rotated in the direction of rotation so rapidly that the scoops engaging into the material transport said material, underneath the axis and beyond, in the direction of the second of the shorter sides and, optionally, sling said material in this direction without loading said material into the scoops. The transport device can be the device according to the invention.

The invention is explained in greater detail in the following with reference to embodiments and the figures. In the drawings:

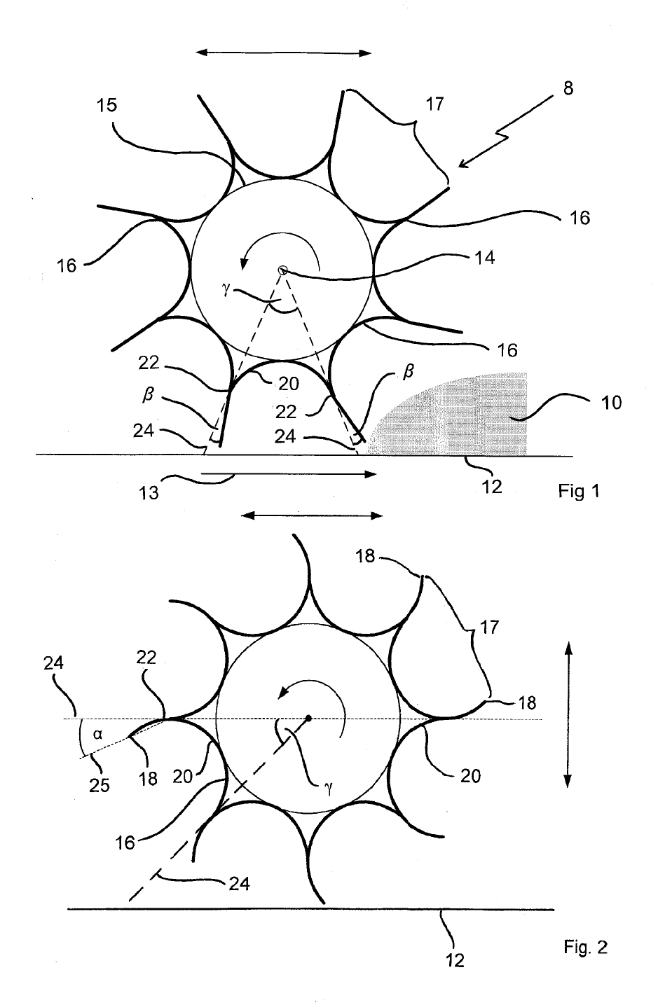

FIG. 1 shows a schematic illustration of a cross section of a first embodiment of the device according to the invention,

FIG. 2 shows a schematic illustration of a cross section of a second embodiment of the device according to the invention,

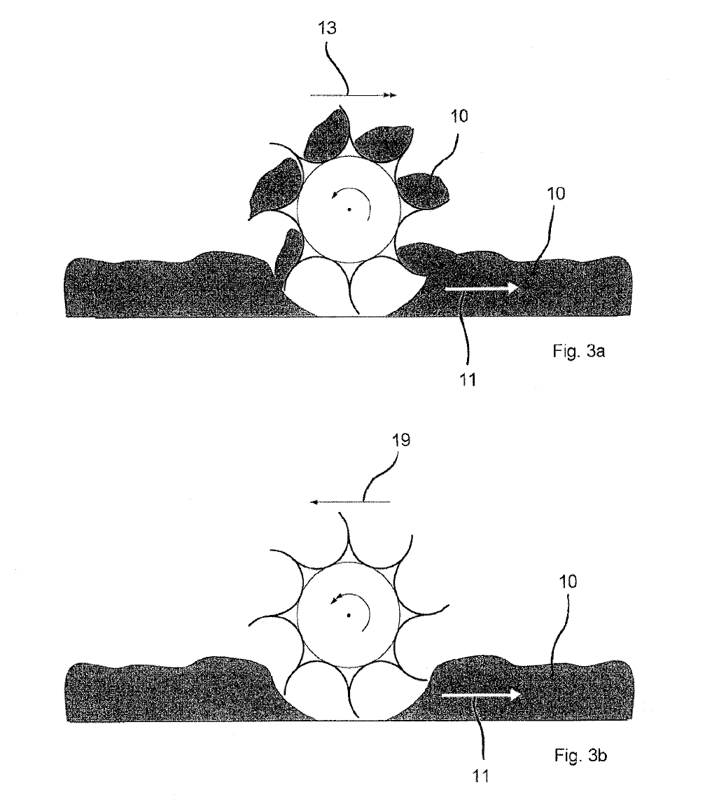

FIG. 3 a, b show a schematic illustration of the method according to the invention,

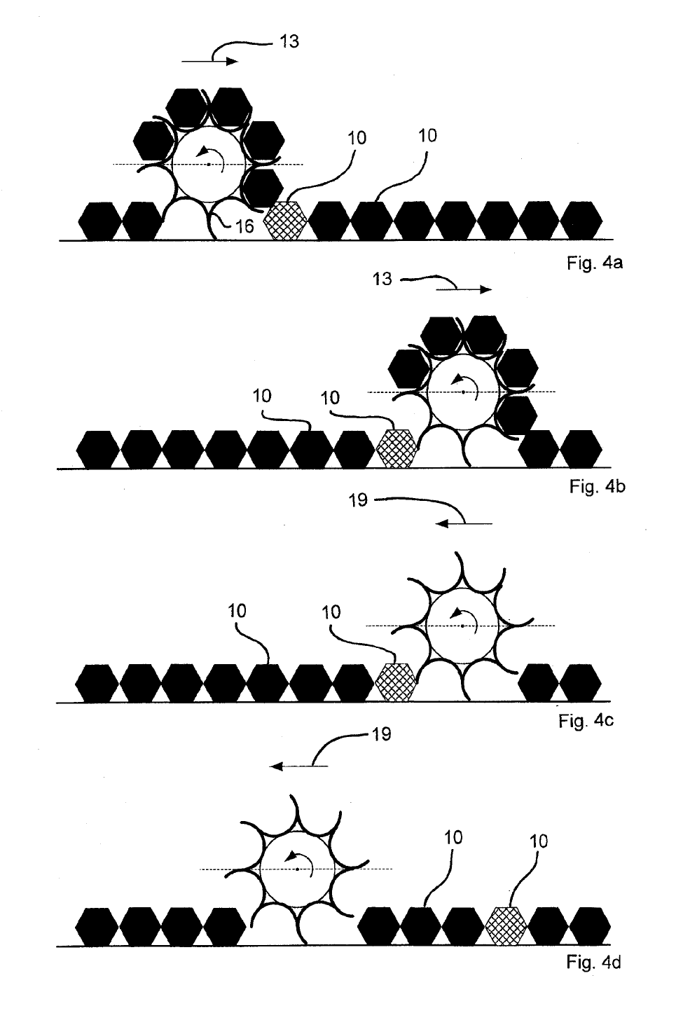

FIG. 4 a-d show another schematic illustration of the method according to the invention,

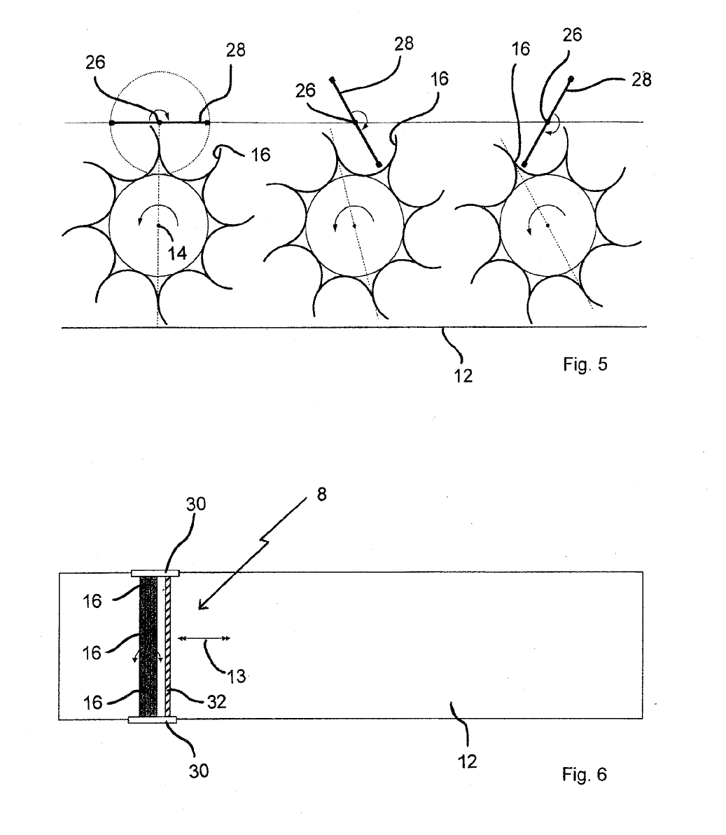

FIG. 5 shows a schematic illustration of a cross section of the sequence of movement of a third embodiment of the device according to the invention, and

FIG. 6 shows a schematic illustration of a top view of a drying facility comprising the device according to the invention.

FIG. 1 shows the material 10 to be dried, which has been placed on the floor 12 and spread out thereon, and the device 8 according to the invention, which has a rotatably mounted axis 14 and a total of eight scoops 16, which extend along the axis 14 and are mounted on a roll 15, in a cross section extending perpendicular to the axis 14 and parallel to the first movement direction 13. The scoops 16 each have an opening 17 facing away from the axis 14. In the operation illustrated here, the device 8 rotates in the counterclockwise direction and is displaced in the first movement direction 13. The wall 20 is intersected at a point 22 by two straight lines 24, each of which extends radially away from the axis, on opposite sides of the scoop 16, wherein an angle β between the straight line 24 and the wall 20 is less than 15°. The angle γ enclosed by the straight lines 24 is approximately 45°.

FIG. 2 shows another embodiment of the device 8 according to the invention, in which, in the cross section extending perpendicular to the axis 14 and parallel to the movement direction 13, the wall 20 of the scoops 16 has two edges 18 in each case, said edges 18 bordering the opening 17 of the scoop 16 on opposite sides of the opening 17. The wall 20 is touched on an outer side of the scoop 16 at the point 22. The part of the wall 20 between the point 22 and the edge 18 closest to this point 22 which part is located at the rear in the direction of rotation forms an angle a with the straight line 24, wherein said angle is approximately 40° here. Providing a wall that is bent about the angle improves the engagement of the scoop 16 into the material 10 and improves the pick-up of the material 10 into the scoop 16. On the opposite side of the scoop 16, another straight line 24 intersects the wall 20 at an inflection point of a curvature formed by the wall 20. The angle γ enclosed by the straight lines 24 is approximately 45°.

FIGS. 3a and 3b and FIG. 4a-d schematically show the implementation of the method according to the invention for transporting the material 10 in the transport direction 11. FIGS. 3a, 4a and 4b show how the axis 14 having the scoops 16 is displaced in the movement direction 13. Thereby the scoops 16 are moved against the material 10, wherein the scoops 16 engage, by the rotation thereof, into the material 10, pick up said material, transport said material in the scoops 16 above the rotating axis 14 and then allow said material to fall out of the scoops 16 as rotation continues in the direction of rotation. The axis 14 is displaced in the first movement direction 13 so far that, as a result, the material 10 is unloaded from the scoops 16 further in the movement direction than where said material was positioned when picked up in the respective scoop 16.

FIGS. 3b, 4c and 4d show how the axis 14 having the scoops 16 is displaced in a second movement direction 19, which is opposite the first movement direction 13, and is thereby rotated so quickly in the direction of rotation that the scoops 16 engaging into the material 10 transport said material underneath the axis 14 and beyond in transport direction 11 without loading said material into the scoops 16.

FIG. 5 schematically shows, in three steps from left to right, a sequence of movement of the device 8 already shown in FIG. 2 having a means 28, which can rotate about the further axis 26, for scratching out the scoops 16. It is clear that the means 28 for scratching engage into the scoop and the rotation of these means 28 is synchronized with the rotation of the axis 14.

FIG. 6 schematically shows a top view of a floor 12, which is designed as a rectangular drying surface and which can be located, e.g., in a greenhouse-type drying hall. A rail, which is not illustrated here, is located along each side of the drying surface, in which said rail the undercarriages 30 of the device 8 according to the invention are guided. The device 8 furthermore has a frame 32, which connects the two undercarriages 30 and stabilizes the entire device 8. In addition, three scoops 16 are evident in the top view.

In the case of the surface illustrated here, the material 10 to be dried can be applied on an application side, on the left, and the dried material 10 can be discharged on a discharge side, on the right. The device 8 according to the invention can be displaced on said rails from left to right and from right to left, although the material 10 is transported toward the right, independently of the movement direction. During the travel from the application side to the discharge side, the axis 14 of the device 8 according to the invention rotates in the movement direction, as viewed from the scoops 16, which are guided over the floor 12, close to the floor. The material 10 is thereby pushed into the scoops 16, is picked up, is lifted above the axis 14 and, finally, is deposited toward the rear. Due to the displacement of the device 8 in the direction of the application side, the material 10 is displaced into this direction. Upon arriving at the discharge side, if the device 8 returns to the application side in the reverse movement direction, the direction of rotation of the axis 14 is retained, but the speed of rotation is increased to the extent that, as a result, the material 10 is slung toward the application side, against the movement direction. The device 8 according to the invention therefore need not complete any “empty trips”, in which no drying material is transported in the direction of the discharge side.

In order to transport moist material 10 to any region of the drying surface in order to mix said moist material with already partially dried material 10, the moist material 10 can be placed into one of the scoops 16 of the device 8 from above, can be displaced with rapid forward travel to the region, and can be unloaded there. It is also possible to transport dried or partially dried material 10 to any region of the drying surface in order to mix this with moist material 10. To this end, the dried or partially dried material 10 can be picked up by one of the scoops 16, by rotating the axis 14, can be displaced with rapid forward travel to the region, and can be unloaded there.

In order to ensure that dried or partially dried material 10 can be discharged on the same side of the drying surface at which the moist material 10 was also applied, the dried or partially dried material 10 can be picked up by one of the scoops 16 by rotating the axis 14, can be displaced with rapid forward travel to this side of the drying surface, and can be unloaded there in a separate region separated from the moist material 10.

Due to the trough-shaped configuration of the scoops 16, said scoops have a high loading capacity, and therefore a relatively large quantity of material 10 can be transported per trip. The scoops 16 can be filled either automatically, e.g., by means of a discharge from a conveyor auger or a conveyor belt, from above or by means of a wheel loader.

The device 8 according to the invention makes it possible to transport a relatively large quantity of material 10 to be dried and to transport said material on the drying surface in the direction of the discharge side, in a relatively short time. As a result, it is possible to realize drying surfaces having a length of more than 200 m without the need to utilize substantially greater investments for a transport, mixing, and turning device than is the case in the prior art for such a device for a substantially shorter drying area.

### LIST OF REFERENCE NUMBERS

8 device
10 material
11 transport direction
12 floor
13 first movement direction
14 axis
15 roll
16 scoop
17 opening
18 edge
19 second movement direction
20 wall
22 point
24 straight line
26 further axis
28 scratching means
30 undercarriage
32 frame

1. A device (8) for turning, mixing, and transporting material to be dried, partially dried material or dried material (10) in a drying facility, in which the material (10) is placed on a floor (12) and spread out for drying, wherein the device (8) has a rotatable axis (14) oriented substantially parallel to the floor (12), trough-like scoops (16) being arranged around and along the axis (14) such that the scoops (16) are moved around the axis (14) in a circle during rotation of the axis (14), wherein the device (8) is arranged above the floor (12) so as to be displaceable in opposite movement directions (13, 19) such that, during displacement above the floor (12), the axis (14) is moved substantially parallel to the floor (12) and in one of the movement directions (13, 19) perpendicular to the axis (14), wherein the device (8) comprises a drive device for rotating the axis (14) having the scoops (16) at an adjustable speed of rotation in one direction of rotation, wherein the scoops (16) each have an opening (17) bordered by opposing edges, wherein the two edges (18) are formed by a wall (20), which extends from one of the edges (18) to the other of the edges (18), or are each formed by a wall (20) connected to a base of the scoop, wherein, for each of the scoops, in a cross section extending perpendicular to the axis (14) and parallel to the movement directions (13, 19), it is possible to draw two straight lines (24), each of which extends radially from the axis, and which enclose an angle γ of 72° at the most, wherein, on opposite sides of the scoop (16) and independently of one another, each of the straight lines (24) either overlaps, in one section, with the wall (20) or one of the walls (20), is tangent to the wall (20) or one of the walls (20) on an outer side of the scoop (16), intersects the wall (20) or one of the walls (20), wherein an angle β between the straight line (24) and the wall (20) or one of the walls (20) is less than 15°, or intersects the wall (20) or one of the walls (20) at an inflection point of a curvature of the wall (20) or one of the walls (20), wherein the straight line (24) and another straight line (25) enclose an angle α at a part (22) of the wall (20) located at the rear in the direction of rotation or at the wall (20) located at the rear in the direction of rotation, wherein the other straight line (25) extends from one point (22), at which the straight line (24) is tangent to or intersects the wall (20) or at which the section ends at a side of the section located closer to the edge (18), wherein this point (22) does not coincide with the edge (18), to the edge (18) located closest to this point (22), wherein 0°<α≦60°.

2. The device (8) according to claim 1, wherein γ is 60° at most, and/or is 0°<α≦50° or 0°<α≦45°.

3. The device (8) according to claim 1, wherein the edge (18) of the part (22) of the wall (20) located at the rear in the direction of rotation or of the wall (20) located at the rear in the direction of rotation forms, in the cross section, an element of the scoop (16) that is spaced furthest from the axis (14).

4. The device (8) according to claim 1, wherein the drive device is designed such that this enables the axis (14) to selectively rotate in the direction of rotation and in another, opposite, direction of rotation.

5. The device (8) according to claim 1, wherein the device (8) is guided in an undercarriage (30) on each of the two sides of the axis (14).

6. The device (8) according to claim 5, wherein the floor (12) is formed by a substantially rectangular surface and the undercarriages (30) are guided on rails or tracks on both sides of the surface or at the longitudinal sides of the surface or at/on a boundary wall arranged along the surface.

7. The device (8) according to claim 1, wherein a shield for preventing a lateral distribution of the material (10) is arranged on both sides of the axis (14) and the scoops (16), laterally at the device (8).

8. The device (8) according to claim 1, wherein the device (8) comprises a means (28), in particular rotating about another axis (26), for scratching or scraping out the scoops (16) in order to free these from material (10) adhering therein.

9. The device (8) according to claim 1, wherein the spacing between the floor (12) and the axis (14) can be changed and/or wherein the device (8) rests on the floor (12) by means of a spacer, which ensures a minimum spacing between the floor (12) and the scoops (16).

10. The device (8) according to claim 1, wherein the device (8) is designed such that at least one uppermost scoop (16) in each case is accessible from above such that it can be filled with material (10).

11. A method for transporting material to be dried, partially dried material or dried material (10) by means of a transport device in a drying facility, in which the material (10) is placed on a floor (12) and spread out for drying, wherein the transport device has a rotatable axis (14) oriented substantially parallel to the floor (12), trough-like scoops (16) being arranged around and along the axis (14) such that the scoops (16) are moved around the axis (14) in a circle during rotation of the axis (14), wherein the transport device is arranged above the floor (12) so as to be displaceable in opposite movement directions (13, 19) such that, during displacement above the floor (12), the axis (14) is moved substantially parallel to the floor (12) and in one of the movement directions (13, 19) perpendicular to the axis (14), wherein the transport device comprises a drive device for rotating the axis (14) having the scoops (16) at an adjustable speed of rotation in one direction of rotation, wherein the floor (12) is formed by an elongated surface, wherein the material (10) is applied on a first of the shorter sides of the surface, is then transported along the surface by means of the transport device, and is discharged on a second of the shorter sides of the surface, wherein the axis (14) is always positioned with such spacing above the floor (12) that the scoops (16) engage into the material (10) during rotation of the axis (14),
wherein the axis (14) is displaced in a first movement direction (13) in the direction of the second of the shorter sides and is thereby rotated in such a direction of rotation that at least one of the scoops (16) close to the floor moves in the first movement direction (13) and against the material (10), wherein the scoops (16), by the rotation thereof, engage into the material (10), pick up said material, transport this in the scoops (16) above the rotating axis (14) and then allow said material to fall out of the scoops (16) as the rotation continues in the direction of rotation, wherein the axis (14) is displaced in the first movement direction (13) to the extent that, as a result, the material (10) is unloaded from the scoops (16) closer to the second side than where said material was positioned when picked up in the respective scoop (16),
and
wherein, as an alternative, the axis (14) is displaced in a second movement direction (19) that is opposite the first movement direction (13) and is rotated in the direction of rotation so rapidly that the scoops (16) engaging into the material (10) transport said material, underneath the axis (14) and beyond, in the direction of the second of the shorter sides and, optionally, sling said material in this direction without loading said material into the scoops (16),
wherein the transport device is a device (8) according to claim 1.

12. (canceled)

13. The use of a device according to claim 1, in order to purposely transport material to be dried, partially dried material or dried material (10) in a drying facility, in which the material (10) is placed on a floor (12) and spread out for drying, to any region of the floor (12),
wherein the axis (14) is positioned with such spacing above the floor (12) that the scoops (16) engage into the material (10) during rotation of the axis (14), wherein the axis (14) is displaced in a movement direction (13) toward the material (10) to be transported and is thereby rotated in such a direction of rotation that at least one of the scoops (16) close to the floor moves in the movement direction (13) and against the material (10), wherein the scoop (16), by the rotation thereof, engages into the material (10) and picks this up, wherein the material (10) is lifted up in the scoop (16) by means of the rotation, wherein the axis (14) and, therefore, the scoop (16) are then held in such a position that the material (10) remains in the scoop (16), wherein the device (8) is then displaced to a position over the region of the floor (12) at which the axis (14) is then rotated such that the material (10) contained in the scoop (16) falls out of the scoop (16),
or
wherein the material (10) is introduced from above into one of the scoops (16) and is held there, wherein the device (8) is then displaced to a position over the region of the floor (12) at which the axis (14) is then rotated such that the material (10) contained in the scoop (16) falls out of the scoop (16).
